(19) United States
(12) Patent Application Publication
(10) Pub. No.: US 2025/0336017 A1
(43) Pub. Date: Oct. 30, 2025

(54) SYSTEM AND METHOD FOR DETECTION AND MITIGATION OF BIAS IN ARBITRATION

(71) Applicant: Alexander Michael Fauble, Arvada, CO (US)

(72) Inventor: Alexander Michael Fauble, Arvada, CO (US)

(21) Appl. No.: 18/650,054

(22) Filed: Apr. 29, 2024

(51) Int. Cl. G06Q 50/18

(52) U.S. Cl. CPC G06Q 50/18

(57) ABSTRACT

A method for mitigating bias in a disputed result involves providing a claimant with a claim and claimed facts, a counter-claimant with a counter-claim and counter-claimed facts, and a panel of arbitrators and a moderator. The method includes moderating comparisons between the claim and counter-claim, and the claimed and counter-claimed facts, to generate arbitrator scores. These scores are used to create rankings for the claimant and counter-claimant, which are then compared to produce a disputant ranking. Bias in the disputed result is mitigated based on the disputant ranking, ensuring a more fair resolution of the unresolved dispute.

### CROSS-REFERENCES TO RELATED APPLICATIONS

This application claims priority to U.S. Provisional Patent Application No. 63/498,821 filed Apr. 28, 2023, entitled “SYSTEM AND METHOD FOR DETECTION AND MITIGATION OF BIAS IN ARBITRATION,” the entire disclosure which is hereby incorporated by reference, for all purposes, as if fully set forth herein.

### TECHNICAL FIELD

The present disclosure relates to methods related to minimizing bias in arbitration or dispute resolution decisions generally.

### BACKGROUND

Numerous methods have been employed in the past to address cognitive biases in dispute resolution, particularly in the context of arbitration processes involving conflicting claims and counter-claims. Traditional approaches have typically involved a single arbitrator or a small panel of arbitrators tasked with evaluating the evidence presented by opposing claimants and/or counter-claimants to reach a decision. However, the reliance on a limited number of arbitrators in such processes has raised concerns about potential biases or subjective judgments influencing the outcome or decision.

In some instances, moderators are used to oversee and administer the arbitration process and add a layer of fairness to the decision-making process. Use of moderators may facilitate constructive discussions between multiple arbitrators, guide the comparison and analysis of claims and counter-claims, and help in reaching a consensus about a disputed question. While use of a moderator can enhance transparency and objectivity to some extent, the effectiveness of mitigating bias in dispute resolution has remained a challenge due to the inherent subjectivity involved in human decision-making.

Moreover, previous approaches have focused on comparing the economic weight of each party's claims and counter-claims directly without considering the legitimacy of any underlying facts used to support each party's position. This limited scope of analysis may result in flawed or incomplete assessments while failing to address potential cognitive biases arising from the interpretation or presentation of facts. As a result, there is a recognized need for an improved method that systematically evaluates both the claims and the supporting facts underlying a claim, relies on multiple arbitrators for diverse perspectives, and incorporates a ranking choice system to minimize possible biases in dispute resolution. However, none of the previously presented approaches have offered a comprehensive solution that combines all of the improved dispute resolution features described in this disclosure.

### SUMMARY

Natural language processing systems are advancing at a dramatic rate. Technological development in Artificial Intelligence (“AI”), specifically Generative AI, and Large Language Models (“LLM's”) far exceeds the current rate of semiconductor shrinkage proposed by Dr. Gordon Moore known as Moore's law. Increasingly, many of the world's largest technology companies are heavily investing in Generative AI development to create a system and set of methods that have been traditionally accomplished by humans. It is therefore contemplated that Generative AI, and LLMs can also be used as part of a larger tool in improving dispute resolution and for minimizing bias in dispute resolution. LLMs can receive and interpret large data inputs such as databases or detailed textual descriptions, and utilize said data inputs to formulate a thorough result or answer. However, LLMs are also currently notorious for sometimes delivering a plausible but false or unreliable response, known as a “hallucination.”

Similarly, it is also well understood that cognitive or other biases can be injected into LLMs based on the data-training sets that the model was trained on. These biases may be eventually observable based on the outputs formulated by LLMs. Data-training sets are simply text or other media produced by human beings used to teach one or more LLMs, and thus the social, political, and cognitive biases that negatively affects human judgment must also be considered and controlled in LLM data sets. Regarding the example of news media, political bias can affect a news outlet's capacity to make objective statements; likewise, the legitimatization of LLMs is prefaced on their ability to produce consistent, unbiased adjudication of differences amongst facts and other disputes. It is contemplated that use of LLMs may also extend to fact-checking organizations, which are ostensibly dedicated toward objectively evaluating narrowly defined claims in terms of objective factual based truth.

Therefore, there is a need to create a system and method capable of detecting and mitigating institutional and/or cognitive biases in both human arbitrations, LLM arbitration, and other dispute resolution methods. The technological problem of mitigating bias in AI applications, which necessarily rely on Natural Language Processing (“NLP”), should simultaneously consider and implement humanistic ideas of fairness and justice, in order to properly legitimize LLM and Generative AI technologies in these fields.

Therefore, embodiments disclosed herein relate to creation of a method comprising a database or organization of a plurality of arbitrators that are assigned a ranking score from one or more third-parties to promote objectivity among its members. In pursuit of this goal, cognitive and institutional biases can be minimized or eliminated by ranking historical and real-time arbitrator performance regarding resolution of available disputes wherein additional incentives to rank or organize the arbitrators may be accomplished using monetary compensation, data, access to electrical capacity, random access memory, or similar operational commodity that drives and inter-connects a system.

Embodiments include one, more, or any combination of the various apparatus and methods described herein. Other features and advantages of the present disclosure will become apparent from the following more detailed description, taken in conjunction with the accompanying, which illustrate, by way of example, the principles of the disclosure.

### BRIEF DESCRIPTION OF THE DRAWINGS

FIG. 1 illustrates a flowchart of a system and method for detection and mitigation of bias in arbitration, according to embodiments of the present disclosure.

FIG. 2 illustrates a flowchart of a system and method for detection and mitigation of bias in arbitration, according to embodiments of the present disclosure.

FIG. 3 illustrates a flowchart of a system and method for detection and mitigation of bias in arbitration, according to embodiments of the present disclosure.

FIG. 4 illustrates a flowchart of a system and method for detection and mitigation of bias in arbitration, according to embodiments of the present disclosure.

FIG. 5 illustrates a flowchart of a system and method for detection and mitigation of bias in arbitration, according to embodiments of the present disclosure.

Corresponding reference characters indicate corresponding parts throughout the several views.

While the disclosure is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

The following detailed description illustrates embodiments of the disclosure and manners by which they can be implemented. Although the best mode of carrying out the present disclosure has been disclosed, those skilled in the art would recognize that other embodiments for carrying out or practicing the present disclosure are also possible.

Embodiments of the present disclosure relate to a method to detect an minimize cognitive or institutional biases in an organization's decision making over time. In some cases, incentivization of arbitrators can be accomplished with a hypothetical-money version of the process that can be operated devoid of actual monetary compensation and marketed as a game. Users can create accounts for a small fee and can be given an arbitrary amount of hypothetical-money that cannot be exchanged for real assets. Users can spend the hypothetical-money on creating their own claims or challenges and earn more money by serving as an arbitrator or moderator or by winning disputes. Intellectual competition and academic interests such as debate programs would serve as the primary motivating factor of users in this game-based embodiment.

Embodiments of the present disclosure are advantageous over the prior art by scoring the arbitrators. Unlike English-common law and arbitration systems in the prior art, the embodiments of the present disclosure allow the parties disputing a claim or result to grade or rank the arbitrators and moderators based on perceived bias. Embodiments of the present disclosure include a method where the parties in dispute can rank the findings or determinations of the arbitrators and moderators, thereby selecting by a result that parties determine is the least biased. This system is unlike methods and systems in the current art, where determinations by arbitrators, moderators, or other fact-finders, can only be appealed to a higher fact-finder or authority. Whereas embodiments of the present disclosure do not rely on a higher authority to detect and mitigate risk, instead creating a process to mitigate bias within the proceedings themselves.

Additionally, according to embodiments of the present disclosure, the arbitrators and moderators are incentivized to mitigate bias. In some cases, the arbitrators and fact finders in the presented embodiments are incentivized by compensation. The findings, or votes, of arbitrators and moderators according the present embodiments can be challenged by the claimants via rankings of the votes after the arbitration has occurred, but before a finding of a prevailing party is made. The parties, i.e. disputants, rank the findings of the each of the arbitrators from most favorable to least favorable. Then, the rankings are combined, and the votes cast by arbitrators that are most favorable to all of the disputants (e.g. the plurality of favorability to all parties) are used to determine the prevailing party. The arbitrator whose vote was most favorable to all parties of a specific dispute receives a score, which is then used to determine how much compensation is due to that particular arbitrator. In some cases, this score (steelman score) is also used to select arbitrators in future dispute resolution, wherein the parties to a subsequent dispute can require a certain threshold score for each arbitrator to then be selected for the subsequent dispute. In some cases, the steelman score allows parties to determine if an arbitrator or moderator is biased, or is able to self-mitigate bias through incentivization. In some cases, this steelman score has a knock-on effect where arbitrators and moderators are more highly compensated based on their steelman score, and thereby incentivized to continue mitigating bias in arbitration.

No human discretion is contemplated for the selection of arbitrators apart from the steelman rankings assessed by claimants and counter-claimants after a dispute is argued and before a verdict is rendered. The arbitrators may be automatically selected via a method utilizing a hardware processor that includes determining a minimum proportion of dispute budget allocatable to each arbitrator in comparison to historical award compensations, steelman score/rankings, and/or prestige ratings/rankings, wherein the hardware processor selects a group, or plurality, or arbitrators who, as have a summed historical award compensation equal to the dispute budget of the present dispute/arbitration proceeding.

Methods and systems disclosed herein may also enable dispute resolutions to be conducted with minimal to no human moderation. This freedom allows disputants and arbitrators to discuss, explore, and address arguments without time or subjective human constraints and creates a visual format that is more easily comprehended than a traditional debate format that is based on time constraints and human moderation.

The contemplated arbitration budget may comprise monetary compensation, other resources, or combinations thereof. In some cases, at least some of the arbitrators may be AI machines, wherein the incentivization can be: added random access memory, bandwidth, data, or other computerized memory allocation. The arbitration budget, in some cases, may therefore include memory allocation, monetary compensation, random access memory allocation, data processing center operational time, or data-processing equivalents thereof. Some human moderation may still be necessary, and for that purpose moderators may be selected based on their tendency to participate in disputes wherein there is a resulting positive correlated steelman rankings among those arbitrators.

Success of the organization depends on the tendency of the rules to self-correct systemic biases that may emerge from one or more arbitrator's decisions. To that end, any systemic biases arising among one or more biased arbitrators should create an incentive and opportunity for more objective less-biased arbitrators to outperform their peers. However, there exists a unique technique or measure that has the potential to serve such an indicator. The proposed measure herein is colloquially referred to as “steelmanning.”

The term “steelman” is derived in contrast to the Strawman logical fallacy, wherein a person mischaracterizes or erroneously describes an opposing rhetorical position creating a metaphorical “strawman” representation of their argument which is an intellectually less developed argument. In contrast, a “steelman” is a more accurate and specific characterization of an opposing rhetorical position; particularly, one that the opponent may agree that fairly and accurately represents their perspective. For biased individuals, systems or AIs, creating a steelman is logically challenging because doing so requires emulating and understanding the thoughts of an opposing rhetorical argument, which cognitive biases seem to prevent or minimize. These biases may also occur in AI output based on the data that the AI was trained on. It is presumed that a person or AI that can accurately summarize the arguments of opposing sides of an issue is in a better position to evaluate the relative strengths and weaknesses of multiple positions and render a more objective conclusion than a person or AI that mischaracterizes the substance of an opposing debate position.

In some cases, steelmanning can used to evaluate one or more possible answers to a question without systemic bias in a manner that produces a useful outcome. As part of dispute resolution, each party, i.e. claimant and counter-claimant, of an unresolved dispute can be required to compare and score or rank written summaries of their own position anonymously written by each of the arbitrators on a panel.

By way of example, a human may dispute one or more proposed results, summaries, reporting, or otherwise distribution of a claim, such as the result of a poll, legal dispute, or new factual report. It is contemplated that the proposed results may originate from a combination of human and AI inputs and processing. Therefore, proposed results may be disputed for potential biases from systematic or cognitive biases incorporated into AI and NLP, stemming from one or more underlying emotional, cognitive, and cultural, (at least) biases also present in human decision making.

By way of example, a human, AI, or combination thereof (a claimant), may dispute a proposed result or actual outcome, submit a claim or challenge to the accepted results to a claim database, wherein the claim may have elements including dispute budget, one or more alleged facts, and a counter-claimant-which may be human, AI, or combination thereof, and one or more alleged counter-claimant facts.

Embodiments of the present disclosure relate to one or more methods wherein arbitrators may be: human, AI, or a combination thereof, and wherein a database of arbitrators may be classified or organized based on categories of AI, human, or a combination thereof.

The rankings provided by opposing sides (disputants generally or claimant/counter-claimants) to a dispute may be aggregated to produce a composite score for each individual arbitrator which will be tied to the individual arbitrator's vote weight, compensation, monetary compensation, and/or data, memory, or other operational equivalent, and performance rating, or prestige rating.

According to embodiments in the present disclosure, each submitted descriptive summary of a dispute requiring resolution is given an accuracy score equal to the difference of the number of arbitrators and its accuracy ranking (as determined by the relevant party giving the accuracy rankings). In some cases, each arbitrator could be assigned a Steelman score equal to the product of the accuracy scores of each summary produced by that arbitrator. The weight of that arbitrator's vote would be equal to the Steelman score as the case may be. An arbitrator's compensation (or proportion of the dispute budget, in some cases the pay level), may be proportional or related to the Steelman score as well. An arbitrator's rating may be later modified over time based on their/its compensation by adding the amount of compensation to the product of 0.9 and their/its prior rating prior to the current scoring. Moderators may also be assigned a similar rating based on their compensation. For possible arbitrator and moderator selection, a Budgetary Compensation Level may be calculated based on the maximum budget of the dispute and the total number of arbitrators and moderators serving.

$${A}_{i , j} = n - {r}_{i , j} \qquad ( Equation 1 )$$

Wherein Equation 1, A_{i,j} is the accuracy score for arbitrator i's summary written for disputant j, n is the number of arbitrators, and r_{i,j} is the rank given by disputant j for the summary written by arbitrator i.

$${S}_{i} = {A}_{i , 1} {A}_{i , 2} \qquad ( Equation 2 )$$

Wherein Equation 2, Sᵢ is the Steelman Score of arbitrator i.

$${T}_{ma x} = {\sum }_{i = 1}^{n} ( {( n - i )}^{2} ) \qquad ( Equation 3 )$$

Wherein Equation 3, Tₘₐₓ is the theoretical maximum possible sum of all Steelman Scores.

$${T}_{m i n} = {{\sum }_{i = 1}}^{n} ( ( n - i ) ( i - 1 ) ) \qquad ( Equation 4 )$$

Wherein Equation 4, Tₘᵢₙ is the theoretical minimum possible sum of all Steelman Scores.

$${T}_{S} = {{\sum }_{i = 1}}^{n} ( {S}_{i} ) \qquad ( Equation 5 )$$

Wherein Equation 5, T_{S} is the total of all Steelman Scores.

$$P = \frac{B}{n + m} \qquad ( Equation 6 )$$

Wherein Equation 6, P is the “pay level” and theoretical maximum average compensation among the moderator and arbitrators, B is the dispute budget, n is the number of arbitrators, and m is the number of moderators (0 or 1).

$${C}_{i} = \frac{{nPS}_{i}}{{T}_{ma x}} \qquad ( Equation 7 )$$

Wherein Equation 7, Cᵢ is the compensation awarded to arbitrator i.

$${C}_{m} = P \times \frac{( {T}_{S} - {T}_{m i n} )}{( {T}_{ma x} - {T}_{m i n} )} \qquad ( Equation 8 )$$

Wherein Equation 8, Cₘ is the compensation awarded to the moderator.

$${R}_{i}^{′} = 0.9 \cdot {R}_{i} + {C}_{i} \qquad ( Equation 9 )$$

Wherein Equation 9, Rᵢ′ is the new rating of arbitrator i, and Rᵢ is that arbitrator's current rating.

$${M}^{′} = 0.9 \cdot M + {C}_{m} \qquad ( Equation 10 )$$

Wherein Equation 10, M′ is the moderator's new rating and M is the moderator's current rating prior to a re-scoring.

According to embodiments disclosed herein, moderators may be selected automatically based on their desired pay level for moderation. Pay level may include memory allocation, monetary compensation, random access memory allocation, data processing center operational time, or data-processing equivalent thereof. Similarly, arbitrators may receive a portion of the dispute budget, based on the results of methods disclosed herein. The portion of the dispute budget associated with a single arbitrator and/or moderator is also known as pay level. Moderators may be selected automatically based on their moderator rating and identified pay level for arbitration. The moderator rating, or prestige ranking, as well as pay level may be contained in a database of moderators, accessible via a network connection. Additionally, arbitrators may be selected automatically based on their arbitrator rating and identified pay level for arbitration. The arbitrator rating, or prestige ranking, as well as pay level may be stored in a database of moderators, accessible via a network connection.

According to embodiments in the present disclosure, possible arbitrators with a desired pay level at or below a dispute budget may be selected from a database to participate in a specific method of mitigating bias of a dispute requiring resolution and/or determining the factual accuracy of a claim submission. Likewise, moderators with a desired pay level at or below a dispute budget may be selected from a database to participate in a specific method of mitigating bias of a dispute requiring resolution and/or determining the factual accuracy of a claim submission.

According to embodiments in the present disclosure, moderators may maximize payment levels by conducting a dispute resolution process so that the arbitrators' accuracy rankings can be positively correlated between opposing parties thereby maximizing receipt of payment level from the dispute budget.

According to possible embodiments in the present disclosure, one or more moderators may be human, which in some cases may be “humans in the loop.” Failure to moderate a dispute resolution in a manner that allows opposing sides of a dispute to claims and counter-claims thoroughly may yield undesirable results or a lower set of accuracy ratings. As such, the accuracy ratings of the two sets of summaries generated in such a scenario would be expected to be negatively correlated. Based on the methods and systems described herein such a failure to moderate may result in reduced monetary compensation for the negatively scored moderator. Alternatively, moderation of a dispute resolution such that both claimant and counter-claimant thoroughly express claim facts and counter-claim facts may result in a positive correlation between data sets and increased payment rates for the moderator.

According to embodiments in the present disclosure, moderator performance may be associated with elements of arbitrator satisfaction following resolution of a dispute. By way of example, moderators could use one or more text inputs to determine the success of the arbitrator's method of disputing a result, or mitigating or identifying bias via a text input to an AI arbitrator. In some cases, moderators may input a request from a set of arbitrators who are human for feedback. In some cases, the set of arbitrators may be human, AI, or a combination thereof. In some cases, arbitrators with high Steelman Scores may be weighted to achieve higher ranking scores for precision identification of the objectivity of moderators such that a weighted feedback system tied to moderator ratings scored by arbitrators may be included in moderator ratings. A moderator weighted feedback system could be quantified by requesting input from AI arbitrators, and/or human arbitrators, to compare the current moderator's performance against the performance of their previous moderator giving a value of up to 1 for better performance by the current moderator and 0 for a worse performance. Moderator payment rates and ratings could thus be calculated using the following equations:

$${C}_{m} = PF \\ {M}^{′} = M \times 0.9 + F \times {C}_{m}$$

$$( Equation 11 above , Equation 12 below )$$

In Equation 11 and Equation 12, F is the average feedback score among all arbitrators.

According to embodiments in the present disclosure, moderation may not be necessary in many circumstances or even at all. In such circumstances, arbitrators may be passive observers of an unmoderated branching tree style dispute resolution process. Each disputant, claim and/or counter-claimant, may posit one or more citations and arguments in support of their submitted claims, or counter-claims, respectively. In some instances, disputants, may also have an option to rebut and/or respond to the original points and arguments of the opposing side. According to some embodiments, arguments may be claims and counter-claims, and/or claim fact sets and counter-claim fact sets, respectively. In some cases, arguments may be organized or presented using a visual user interface such as a video display that allows arbitrators to easily review and evaluate the resulting argument tree; in other cases, the arguments may be assessed using a hardware processor.

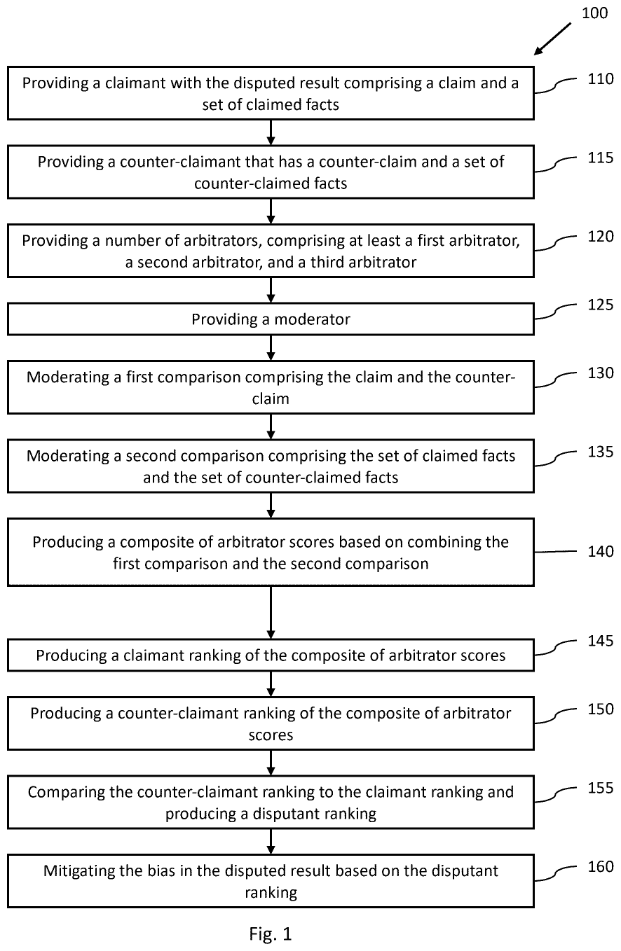

According to various embodiments, FIG. 1 illustrates an overview method 100 for detecting and mitigating bias in arbitration and/or dispute resolution, performed in accordance with one or more embodiments.

Embodiments of the present disclosure relate to a method 100 of mitigating bias in a dispute wherein a claimant that has decided to challenge the factual accuracy of a result or claim, which may be, but is not limited to one or more statements, purported facts, and/or LLM generation. In some cases, the claimant includes the disputed result by including of a claim and a set of claimed facts which are a component of the claimant's overall claim. 110 Further, to initiate one of the methods as disclosed herein, a counter-claimant may submit a counter-claim and a set of counter-claimed facts may also comprise a component 115 of the methods as disclosed herein, such as a counter-claim. In some case the counter-claim is the disputed result. The counter-claim may also be stated, in some proportion, as the result of AI, and LLM or other NLP.

Embodiments of the present disclosure relate to a method 100 of mitigating bias in an unresolved dispute comprising a first arbitrator, a second arbitrator, and a third arbitrators 120, ideally comprising an odd number of arbitrators. The selected arbitrators may be human, AI, or combination thereof, and wherein a database of possible arbitrators may be organized based on categories of AI, human, or a combination thereof.

The method 100 may also include providing a moderator 125 wherein the moderator 125 will be enabled to moderate a first comparison including the claim and the counter-claim 130. The moderators may also moderate a second comparison including the set of claimed facts and the set of counter-claimed facts 135.

According to embodiments of the present disclosure, the first comparison can be and analysis of claims and counter-claims submitted by the claimant and the counter-claimant into the claim template by the arbitrators. In some cases, the arbitrators may provide questions to the moderator that can be delivered to the claimants and counter-claimants. In some cases, the second comparison may include the analysis of claimed facts and counter-claimed facts submitted in response to the questions supplied to the moderator by the arbitrators in the first comparison. By way of example only, the arbitrators may examine the claims and counter-claims during the first comparison, and respond with questions to the moderator who then supplies those questions to the claimant and counter-claimant (i.e. disputants). Then the disputants have an opportunity to supply supporting arguments, rebuttals, and additional facts to the moderator via the claim template, which can be the set of claimed facts, and/or the set of counter-claimed facts Then, in some cases, the arbitrators may analyze the answers to the questions provided to the disputants in the second comparison and determine the claim by each choosing a prevailing party of the dispute based on the first and second comparison.

According to embodiments of the present disclosure, the first and second comparisons can occur across one or more durations. Importantly, the specified duration, which can be one or more lengths of time, can be set by taking an average of all previous methods of detection and mitigation of bias in arbitration. In some examples, this can be set between the arbitrators over a specified duration such as a duration between 0.1-24 hours per response or a duration for the total arbitration to be completed. Furthermore, in some cases the specified duration can be determined by estimating an operational time via the hardware processor, wherein the claimant facts and counter-claimant facts may be consolidated in the claim template. In some cases, the claim and counter claims may be consolidated in the claim template. Consolidation in the claim set can be accomplished using hardware processor wherein the claim template is determined to have a total file size representative of the complexity of the arbitration, and the number of facts presented by the claimant and the counter-claimant. some cases, the size of the file size of the claim template can be used to determine the specified duration in time, wherein a larger file size of the claim results in a longer set duration of time.

The method 100 may include producing a composite of selected arbitrator scores based on combining the first comparison and the second comparison 140. Combining the first comparison and second comparison can be accomplished by a plurality of arbitrators. The plurality of arbitrators may be the first arbitrator, second arbitrator, and the third arbitrators. In some cases, each of the arbitrators may consider the claim and counter-claim 130 as well as the claimed facts and counter-claimed facts 135, in some cases is the arbitration data set. In some cases, the arbitrators will each define a prevailing party via analysis of the arbitration data set.

In some cases, analysis of the data set includes defining a value for each fact or argument in the arbitration data set. Defining a value could be assigning a negative value for a fact and/or argument, and/or assigning a positive value for a fact and/or argument. Analysis of the arbitration data set could include summing the negative and positive values, and the party with more positive values may be determined to be the prevailing party. In some cases, the arbitrator will assign a positive or negative value based on comparing facts to historical precedents, common law, US law, state law, religious laws, or a constitution. In some cases, the constitution may be drafted and incorporated into a software that operates the arbitrator.

In some cases, in the method 100 the composite of arbitrator scores is comprised of a first arbitrator score, a second arbitrator score, and third arbitrator score; producing a claimant ranking of the composite of arbitrator scores 145; producing a counter-claimant ranking of the composite of arbitrator scores; comparing the counter-claimant ranking to the claimant ranking and producing a disputant ranking 155; and mitigating the bias in the disputed result based on the disputant ranking 160.

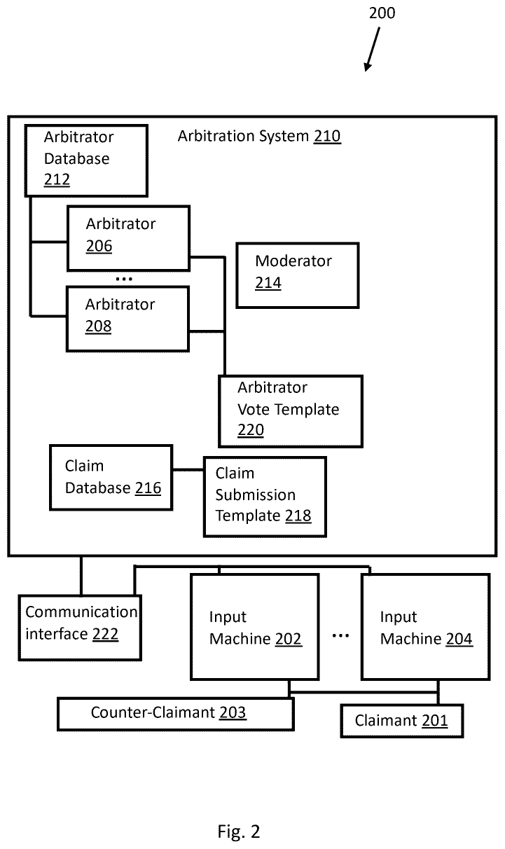

In some implementations, each of the method 100 and/or method 400 may be performed at an arbitration system 210 such as the system 200 shown in FIG. 2. For instance, the method 400 may be performed at the arbitration system 210. The arbitration system 200 includes one or more input machines 202 through 204 in communication with an arbitration system 210. The arbitration system 210 includes arbitrators 206 through 208, each in communication with the arbitrator database 212, a moderator 214, and arbitrator vote template 220. The arbitration system 210 may also include a claim submission 216. The system 200, may include a communication interface 222 configured to communicate with input machines 202 through 204, wherein the input machines 202 through 204 can communicate with a claimant 201 and counter-claimant 203.

According to various embodiments, input machines 202 through 204 may be any suitable computing device or system across a network such as the internet. For instance, an input machine 202 may be a laptop computer, desktop computer, mobile computing device, or similar. Alternatively, or additionally, an input machine 202 may be an interface through which multiple remote devices communicate with the arbitration system 210.

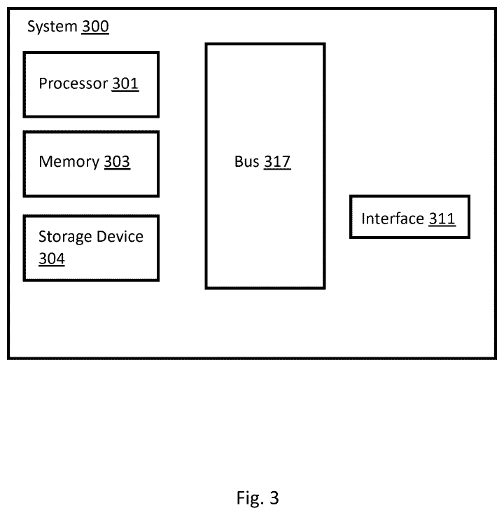

FIG. 3 illustrates one example of a computing device system 300, configured in accordance with one or more embodiments. According to various embodiments, a computing device system 300 suitable for implementing embodiments described herein includes a processor 301, a memory module 303, a storage device 305, an interface 311, and a bus 315 (e.g., a PCI bus or other interconnection fabric.) Computing device system 300 may operate as variety of devices such as an application server, a database server, or any other device or service described herein. Although a particular configuration is described, a variety of alternative configurations are possible. The processor 301 may perform operations such as those described herein. Instructions for performing such operations may be embodied in the memory bank 303, on one or more non-transitory computer readable media, or on some other storage device. Various specially configured devices can also be used in place of or in addition to the processor 301. The interface 311 may be configured to send and receive data packets over a network. Examples of supported network interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Embodiments of the present disclosure relate to a method further including: ranking the first arbitrator, the second arbitrator, and the third arbitrator based on the disputant ranking; assigning a Steelman Score to the first arbitrator, the second arbitrator, and the third arbitrator, respectively, based on the disputant ranking; and calculating a maximum Steelman Scores for the first arbitrator, the second arbitrator, and the third arbitrator, and updating the first arbitrator, the second arbitrator, and the third arbitrator's ongoing Steelman Score based on the most recent disputant ranking. Maximum Steelman Scores can be calculated as shown in Equations 1-3.

Embodiments of the present disclosure relate to a method further including: providing a dispute budget; and calculating arbitrator award compensation upon resolution of the dispute based on: a Steelman Score Sum including the Steelman Score to the first arbitrator, the second arbitrator, and the third arbitrator; and of the Steelman Score of the first arbitrator, the dispute budget, and the number of arbitrators. The award compensation may be calculated as shown in Equations 6-8.

In some cases, the award compensation may be electronically allocating and distributing the compensation provided in the dispute budget automatically upon resolution of the dispute to each arbitrator via an digital wallet in a user account they hold. The digital wallet may be configured to tally or record one or more arbitrator data values and an amount of memory or data historically allocated based on previous arbitrations. In some cases, proposed award compensation may be delivered to one or more participating arbitrators via a token wherein the token represents a portion of the dispute budget, and that particular arbitrator's compensation. In some cases, the token may be recorded via a blockchain. In some cases, the distribution and compensation provided by the awarded compensation via the disputant rankings may be recorded in a ledger and then delivered to the arbitrator based on the ledger recordation. In some cases, the digital wallet configured to receive a token, hypothetical money, and/or a random-access memory allocation.

Embodiments of the present disclosure relate to a method further including: calculating a first arbitrator rating based on the first arbitrator award compensation and an arbitrator constant.

Embodiments of the present disclosure relate to a method, further including: calculating one or more Minimum Steelman Scores; calculating one or more Total Steelman Scores; and calculating a first moderator award compensation based on the dispute budget, the Maximum Steelman Scores, the Minimum Steelman Scores, and the Total Steelman Scores, as shown in Equations 1-12.

Embodiments of the present disclosure relate to a method, further including: calculating a first moderator rating based on the first moderator award compensation and a moderator constant, as shown in Equations 1-12.

Embodiments of the present disclosure relate to a method, further including: selecting the number of arbitrators by combining the first arbitrator rating with the dispute budget further including budget threshold value, as shown in Equations 1-12.

Embodiments of the present disclosure relate to a method, further including: selecting the moderator by combining the first moderator rating and the dispute budget.

Embodiments of the present disclosure relate to a method further including providing a questionnaire by the claimant and the counter-claimant to the arbitrators, further comprising a claimant test and a counter-claimant test respectively. The questionnaire may be a set of questions unrelated to the claim and counter-claim that is directed to the arbitrator from the disputant, the claim and counter-claim. The questionnaire may contain one or more questions, wherein responses from the arbitrator may be graded by the disputant into positive or negative category. The score of the questionnaire by the arbitrator is therefore determined based on the sum of the graded questionnaire by the disputant. In some cases, the answering and grading of the questionnaire may be limited to a short time, 0.1-1 hour. In some cases, the questionnaire may be prepared by a generative AI that generates a questionnaire based on a list of moral or ethical preferences, a worldview, selected by the respective disputant and reported to the AI. The sum of the graded questionnaire can be determined by the AI that directed the questionnaire to the arbitrator from the respective disputant, as the disputant has already indicated a worldview to compare to the responses by the arbitrator on the questionnaire.

Embodiments of the present disclosure relate to a method, wherein producing the composite of arbitrator scores is further based on combining the first comparison, the second comparison and the questionnaire, wherein the composite of arbitrator scores are further included of a first arbitrator questionnaire score, a second arbitrator questionnaire score, and third arbitrator questionnaire score. In some cases, the composite of the questionnaire score is based upon the results of each questionnaire, wherein the results of each of each questionnaire is based upon a negative or positive value assigned to each response of the questionnaire by each arbitrator, respectively, by the respective disputant. The summed total of each response according to a specific questionnaire by each arbitrator as graded by the respective disputant is the questionnaire score. The questionnaire score may be added to the arbitrator score, resulting in the composite score, in some cases. In some cases, the ranking of the arbitrators based on the composite score is ranked wherein the arbitrator with the largest positive score may be ranked first, and in such cases the prevailing party selected by the arbitrator with the largest positive score may be considered the winner, or overall prevailing party. In some cases, the smallest score, or a negative value, may be used to select the arbitrator whose prevailing party is the overall prevailing party, or winner.

Embodiments of the present disclosure relate to a method, wherein disputants are given the opportunity to submit one or more questionnaires to the arbitrators of the dispute via an electronic submission form. Disputants may use these questionnaires to assess the possible level of consensus the arbitrators have with their position.

Embodiments of the present disclosure relate to a method, wherein producing the disputant ranking further includes: weighting the first arbitrator score by comparing the claimant provided questionnaire and the counter-claimant questionnaire results to the first arbitrator score, weighting the second arbitrator score by comparing the claimant test and the counter-claimant test results to the second arbitrator score; and weighting the third arbitrator score by comparing the claimant test and the counter-claimant test results to the third arbitrator score.

Embodiments of the present disclosure relate to a method, wherein disputants may be given access to an electronic form whereby they can review and rank the responses to the arbitrator questionnaires by order of preference. Disputants are unable to in certain cases, view the responses made to their opponents' questionnaire, nor view the votes of the arbitrators they are ranking. In some cases, the highest ranked responses are awarded higher scores.

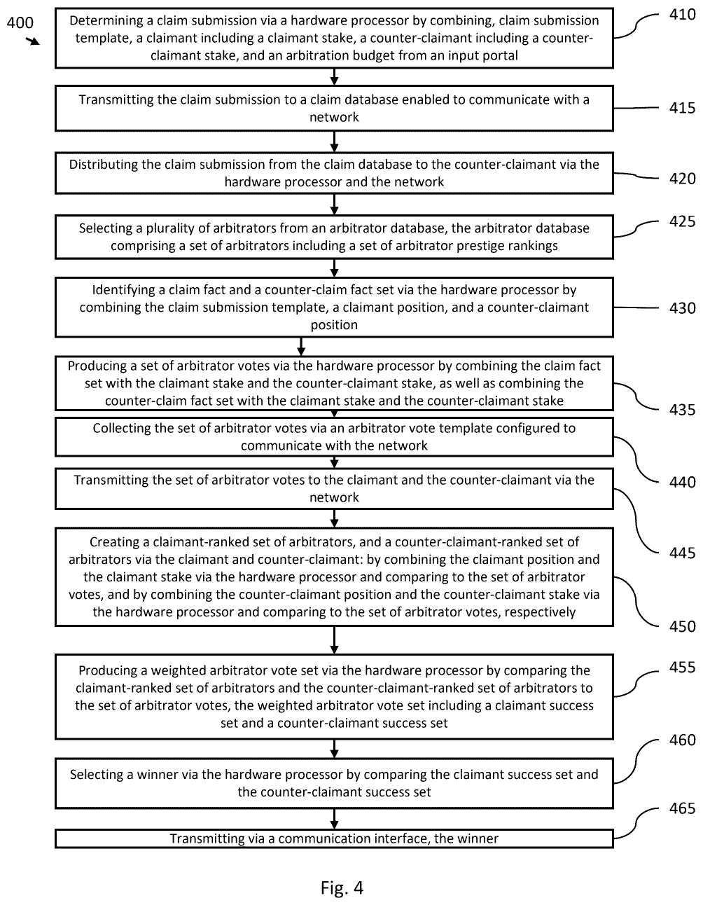

Embodiments of the present disclosure relate to a method 400 as shown in FIG. 4 including: determining a claim submission via a hardware processor, which can occur by combining, claim submission template 216, a claimant including a claimant stake, a counter-claimant including a counter-claimant stake, and an arbitration budget from an input portal 410. The claim submission can then be transmitted to a claim database enabled to communicate with a network 415.

Embodiments of the present disclosure relate to a method 400, wherein determining the claim submission includes a group or plurality of arbitrators deciding if the claimant's claim or the counter-claimant's claim will prevail, and thereby selecting whether the claimant or the counter-claimant is the prevailing party. In some cases, determining the claim submission includes the claimant and counter-claimant analyzing each arbitrators' vote, i.e., each arbitrator's selection of a prevailing party with that arbitrator's corresponding explanation of the selection. In some cases, the claimant and counter-claimant will then each, separately, rank each of the arbitrator's votes in order beginning from most favorable to least favorable.

According to embodiments disclosed herein, disputants, (i.e. claimant and counter-claimant) as a way to mitigate bias may rank the arbitrator votes in order beginning from most favorable to least favorable via ranked voting, or ranked-choice voting. In some cases, combining the disputants ranking of the arbitrators may utilize a plurality voting rule, and/or a positional rule with positive and negative integers. In some cases, disputants may rank the arbitrator's votes via Dowdall's system, where each successively ranked vote is divided by the number of integers from the most favorable arbitrator's vote.

According to embodiments disclosed herein, disputants, (i.e. claimant and counter-claimant) as a way to mitigate bias may rank the arbitrator votes in order of most favorable to least favorable via rated voting, i.e. cardinal voting. It is contemplated that the disputants may use rated voting including, but not limited to: a score voting system approval voting, combined approval voting, range voting, five-star classification systems, highest median rules, STAR (score then automatic runoff). It is also contemplated that the disputants may rank the arbitrator's votes via Phragmen's voting rules and/or Thiele's voting rules, including but not limited to: proportional approval voting, fair majority voting, or method of equal shares.

Embodiments of the present disclosure relate to a method, wherein the claimant defines the claim in precise terms in the form of a thesis statement that they will have to rhetorically defend in the event of an unresolved dispute. The claimant will also have to define the stakes for both disputants as well as the arbitration budget, or dispute budget, to be paid/distributed by the non-prevailing party to the prevailing party and to the arbitrators, the arbitrators associated with judging the unresolved dispute.

The method 400 may further include distributing the claim submission from the claim database to the counter-claimant via the hardware processor and the network 420. In some cases, the method 400 includes selecting a plurality from an arbitrator database, the arbitrator database including a set of arbitrators including a set of arbitrator prestige rankings 425. In some cases, the method 400 includes identifying a claim fact and a counter-claim fact set via the hardware processor by combining the claim submission template, a claimant position, and a counter-claimant position 430;

Embodiments of the present disclosure relate to a method wherein the counter-claimant may initiate a dispute electronically by electronically paying a deposit into a holding or escrow account as a reserve against the potential liabilities of not prevailing in the dispute. This in turn commits the claimant to comparable liabilities as defined by the claim template. A network-connected input device automatically and electronically informs the claimant that their claim has been challenged.

In some cases, the method 400 includes producing a set of arbitrator votes via the hardware processor by combining the claim fact set with the claimant stake and the counter-claimant stake, as well as combining the counter-claim fact set with the claimant stake and the counter-claimant stake 435. In some cases, the method 400 includes, collecting the set of arbitrator votes via an arbitrator vote template configured to communicate with the network 440. In some cases, the method 400 includes transmitting the set of arbitrator votes to the claimant and the counter-claimant via the network 445. In some cases, the method 400 includes creating a claimant-ranked set of arbitrators, and a counter-claimant-ranked set of arbitrators via the claimant and counter-claimant: by combining the claimant position and the claimant stake via the hardware processor and comparing to the set of arbitrator votes, and by combining the counter-claimant position and the counter-claimant stake via the hardware processor and comparing to the set of arbitrator votes, respectively 450. In some cases, the method 400 includes producing a weighted arbitrator vote set via the hardware processor by comparing the claimant-ranked set of arbitrators and the counter-claimant-ranked set of arbitrators to the set of arbitrator votes, the weighted arbitrator vote set including a claimant success set and a counter-claimant success set 455. In some cases, the method 400 includes selecting a prevailing party via the hardware processor by comparing the claimant success set and the counter-claimant success set 460, an in some cases transmitting via a communication interface 222, the prevailing party 465.

Embodiments of the present disclosure relate to a method, wherein selecting the plurality from the arbitrator database, further includes: assigning a prestige ranking to each of the plurality of arbitrators based on a weighted historical arbitrator vote set wherein the arbitrator database further comprises a historical arbitrator vote set, a historical claimant-ranked set of arbitrators, a counter-claimant set of arbitrators and a historical arbitration budget, and a historical winner; producing the weighted historical arbitrator vote set by via the hardware processor by comparing the historical arbitrator vote set, the historical claimant-ranked set of arbitrators, the counter-claimant set of arbitrators, the historical arbitration budget, and the historical winner; and comparing the arbitration budget to the prestige ranking of each of the plurality.

Embodiments of the present disclosure relate to a method, wherein the hardware processor communicating with arbitrator database via a network automatically and electronically selects arbitrators. Each arbitrator has an individual prestige ranking and arbitrator award compensation based on their performance as arbitrators in previous historical debates. Invitations are sent to the most prestigious arbitrator whose award compensation fits the dispute budget and number of arbitrators defined in the claim template, and final selection prioritizes the most prestigious arbitrators who may be selected.

Embodiments of the present disclosure include a method including, one or more arbitrators applying an offset variable to their prestige rating to increase or decrease the frequency of selection for a service offer. In some cases, applying an offset may be a portion of the proposed award compensation that the arbitrator would receive as a part of the arbitration proceedings. By way of example only, if an arbitrator was scored as the highest ranked out of a set of arbitrators selected for a particular dispute resolution, and that arbitrator was thereby enabled to receive 10% of a total dispute budget, the arbitrator could apply an offset, by which the arbitrator hedges 5% of the dispute budget against the final result/selected prevailing party. Therefore, in this example, the arbitrator would only receive up to 50% of their normally-calculated award compensation, or roughly 5% of the dispute budget. In this example, the offset reduces the required dispute budget for the arbitrators to be selected for the arbitration proceedings.

Embodiments of the present disclosure relate to a method, wherein producing the weighted historical arbitrator vote set further includes comparing the historical arbitrator vote set, the historical claimant-ranked set of arbitrators, the counter-claimant set of arbitrators, the historical arbitration budget, and the historical prevailing party with an arbitrator Schelling factor, wherein the arbitrator database is further configured to comprise the arbitrator Schelling factor.

Embodiments of the present disclosure relate to a method, wherein determining the claim submission further includes: transmitting a claimant-Turing test and a counter-claimant Turing test via the network to the arbitrator vote template further configured to contain an arbitrator Turing set; and creating and delivering the arbitrator Turing set via the hardware processor by submitting the claimant-Turing test and the counter-claimant Turing test to the plurality of arbitrators

According to embodiments of the present disclosure, disputants may each submit a Turing test to the arbitrators. The Turing test may be a comparative Ideological Turing Test. In some cases, the disputants may draft Turing test questions relevant to their arguments, claims, or facts to test the arbitrators' understanding. Each arbitrator drafts responses to both Turing tests, (The Turing set: responses to a claimant and a counter-claimant test) which are anonymized and returned to their respective disputants. The disputants score the responses either by ranking them in order of preference or by awarding a limited number of points to each response. An overall performance score is calculated based on the product of both scores given to their responses, or by simply taking the lower of the two scores. This performance score may be included in the arbitrators' rankings, the arbitrator database, and/or the prestige rating. In some cases, the disputants may rank the arbitrators' votes based at least in part on the arbitrators' responses to the Turing test.

Embodiments of the present disclosure relate to a method, wherein determining the claim submission further includes producing the weighted arbitrator vote set via the hardware processor by further comparing the claimant-ranked set of arbitrators and the counter-claimant-ranked set of arbitrators to the arbitrator Turing set.

Embodiments of the present disclosure relate to a method, wherein determining the claim submission further includes selecting one or more arbitrators from the arbitrator database including a set of arbitrator geolocation elements; and also, further includes: diversifying the set of arbitrators via the hardware processor by comparing the set of arbitrators to the set of arbitrator geolocation elements.

Embodiments of the present disclosure relate to a method, wherein determining the claim submission further includes: identifying a set of claimant geolocation elements and a set of counter-claimant geolocation elements; and wherein selecting arbitrators from the arbitrator database further comprises comparing the set of arbitrator geolocation elements to the set of claimant geolocation elements and the set of counter-claimant geolocation elements. In some cases, the set of claimant geolocation elements, counter-claimant geolocation elements, and/or arbitrator geolocations elements can be geographically relevant variables related to the dispute, including, but not limited to: locality or geographical locations of specific claim elements such as locations, geo-graphically related cultural norms, geographically related linguistic or terminology, geographically related political or religious norms, or geographically related environmental factors like local weather and/or climate. In some cases, selection of the arbitrators by comparing the set of arbitrator geolocation elements to the set of claimant geolocation elements and the set of counter-claimant geolocation elements, includes tallying or counting the relevant variables that are similar, or in some cases dissimilar, between the claimant and the arbitrator, as well as between the counter-claimant and the arbitrator. In some cases, if the number of similar geographically relevant variables between the arbitrator and the claimant outnumbers the similar geographically relevant variables between the arbitrator and the counter-claimant, that particular arbitrator may not be selected via the arbitrator database. In some cases, the vote of that particular arbitrator may instead be geo-weighted.

Embodiments of the present disclosure relate to a method, wherein determining the claim submission further includes: Geo-weighting the weighted arbitrator vote set via the hardware processor by comparing the claim fact set and the counter-claim fact set. In some cases, if the number of similar geographically relevant variables between a particular arbitrator and the claimant outnumbers the similar geographically relevant variables between the arbitrator and the counter-claimant, and/or the number of geographically relevant variables in the claim fact asset and/or counter-claim fact set, that particular arbitrator's subsequent vote may be geo-weighted whereby that particular arbitrator's vote is automatically given a lower ranking when the disputants rank the arbitrator's votes.

Embodiments of the present disclosure relate to a method, wherein determining the claim submission further includes: delivering a prevailing party's share of the arbitration budget to the prevailing party, and arbitration share to the set of arbitrators. In some cases, the prevailing party's share of the arbitration budget may be delivered to a digital wallet or account linked to the claim submission template 218 and/or input machines 202 via the network and the communication interface 222. Similarly, arbitrators may receive their portion of the arbitration share via the network and arbitration system 210. The portion of the arbitration share received by the arbitrators may be recorded in the claim database 216. In some cases, the portion of the arbitration share received by the arbitrators stored in the claim database 216 can be used to determine the arbitrator's prestige ranking, where the arbitrators who have received greatest proportions of arbitration shares have the highest prestige ranking. In some cases, the prestige ranking determines a minimum disputant budget threshold that which an individual arbitrator will be selected for a specific claim determination.

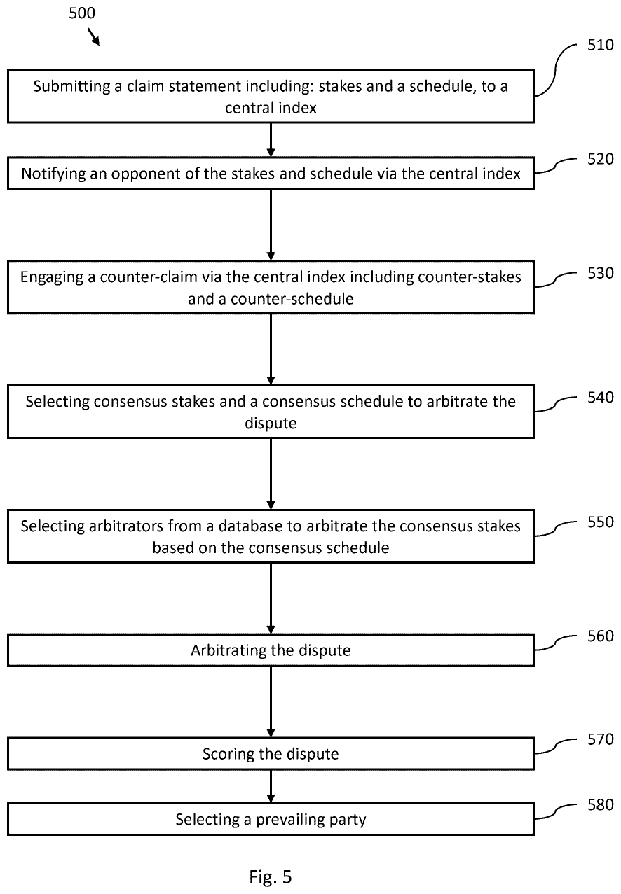

As shown in FIG. 5 embodiments of the present disclosure relate to a method 500 of mitigating bias in a dispute that includes submitting a claim statement with stakes and a schedule, to a central index 510. In some cases, the claim statement lays out a narrative of the dispute and includes the proposed stakes, or costs, of deciding the dispute. The submission of the claim statement may be accomplished via an input machine connected to the central index via a network connection, where the central index has a communication interface 222 configured to accommodate the stakes and schedule of the dispute. The schedule may comprise a standard timeline, custom timeline, or ideal suggestion of a timeline to resolve the dispute and may include, but is not limited to the timing of: submitting facts, submitting arguments, replying to questionnaires, and submitting counter arguments to the central index. In some cases, the central index is a publicly viewable database accessible via a communication interface 222 accessible via a web-browser or application.

As shown in FIG. 5 embodiments of the present disclosure relate to a method 500 of mitigating bias in a dispute that includes notifying a possible opponent of the proposed dispute, stakes, and schedule via the central index 520. In some cases, an opponent may be an individual named in the original claim, a volunteer, or an AI assigned as the opponent of the claim. The method 500, may also include engaging a counter-claim via the central index including counter-stakes and a counter-schedule 530. The counter-stakes and counter-schedule may be submitted by the opponent to the claim wherein the opponent is provided one or more scheduling notifications. In some cases, the method 500 includes selecting consensus stakes and a consensus schedule to arbitrate the dispute 540 which may be accomplished by an AI analysis of the claim and counter-claim, or by a moderator, who can be selected via the central index. In some cases, the consensus stakes and/or consensus schedule may include pay-outs of the consensus stakes to a prevailing party, arbitrators, and/or the moderator.

The method 500 may also include selecting one or more arbitrators from a database to arbitrate the consensus stakes based on the consensus schedule 550 where the arbitrators may be individuals connected to the central index via a network connection and an input machine 202; and in some cases, the arbitrators may be AIs connected to the network and central index via an application programming interface (“API”) configured to communicate with a LLM and/or any other type of AI.

The method 500 also includes arbitrating the dispute which may include each party (i.e. claim and counter-claim, and/or claimant and opponent) submitting a statement and supporting arguments for the arbitrators to review. In some cases, the parties' statements and supporting arguments are reviewed and evaluate by the moderator while adhering to the consensus schedule. In some cases, arbitration of the dispute also includes the parties' submission of one or more rebuttals via the central index, and evaluated by the arbitrators within the timeline of the consensus schedule. The method 500, may also include scoring the dispute wherein each of the arbitrators determines a prevailing party via a majority vote, then the parties each ranking the votes of each of the arbitrators, wherein the top-ranked arbitrator by the parties is chosen to identify a prevailing party. After the identification of the prevailing party, the consensus stakes are delivered to the prevailing party, arbitrators, and moderator, respectively based upon the consensus schedule.

Embodiments of the present disclosure include a user video interface that is configured to visually display disputes and their current status on a computer or other input machine 202. In some cases, the virtual interface will connect a user's video display to a graphical user interface (“GUI”) configured to demonstrate an argument map comprising inputs from a claimant and counter-claimant as well as arguments from both the claimant and counter-claimant, one or more avatars representing the assigned arbitrators, and an avatar representing the moderator. In some cases, the argument map may be comprised of a branching debate tree comprising a descending or ascending GUI display of arguments and responses to arguments made by both the claimant and counter-claimant with an x-axis and a y-axis. The output may comprise a branching debate tree including a thesis, conclusion, and/or initial premises, which can also be identified as a claim and supporting facts, or similarly identified as an initial claim and claim fact set. In some cases, the output may further comprise one or more co-premises, objections, counterarguments, rebuttals, and lemmas. The GUI may further comprise display of an output with a bisection bisecting the x-axis to display two parallel contentions, such as a claim and counter-claim, wherein each bisected portion of the 2d image, the claim is represented via the GUI with one or more longitudinal images parallel along the along the y-axis including, but not limited to GUI representations of respective argument maps. In some cases, the respective arguments may include, but are not limed to premises, objections, rebuttals, counterarguments, citations, and lemma.

Embodiments of the present disclosure include a GUI including a searchable or organized index of unresolved disputes that is publicly accessible, wherein the thesis statement, the proposed stakes, arbitration budget, debate format, number of jurors/arbitrators, and time management rules are presented along one or more rows or searchable data sets.

Embodiments of the present disclosure may include an input machine 202 using a network connected web-browser. In some cases, the claim template may be displayed via the web-browser or application and include user inputs for a claimant-input dispute budget and desired steelman score of arbitrators. In some cases, the claim template may be transmitted via the network to a hardware processor. In some cases, the claim template may include, but is not limited to, inputs for premises, objections, rebuttals, counterarguments, citations, and lemma.

Embodiments of the present disclosure may include a method including, when a claim is challenged, wherein a certain number of arbitrators/jurors are electronically notified to serve as possible arbitrators to resolve the challenged claim. Whether an arbitrator is electronically notified may depend on the following criteria: a) The arbitrator's prestige rating, factoring in their offset, must be below the arbitration budget divided by the number of arbitrators serving on the panel, and b) The arbitrator must be among the highest ten percent of rated arbitrators that meet the first criterion.

Embodiments of the present disclosure include a method including a first electronic notification to one or more arbitrators within the arbitrator database, wherein a response to the electronic notification must be made by the arbitrator within a specified interval such as between 0.01-24 hours to accept an offer to arbitrate a dispute.

Embodiments of the present disclosure may also include a method comprising a secondary set of electronic notifications to one or more arbitrators that may be automatically sent to the next highest rated arbitrators within the arbitrator database based on the number of arbitrators that accept the first electronic notification. This process may be repeated until a sufficient number of arbitrators from the arbitrator network are selected. If a surplus number of arbitrators respond to the electronic notification to serve, the highest rated arbitrators among those who accepted will be selected to fill the panel. If an insufficient number of arbitrators accept the invitation, the dispute may be canceled and any deposits may be subsequently refunded. The network may as an alternative also automatically recommend to the claimant a specific increase the value offered for the arbitration budget, i.e. dispute budget, in order to encourage greater arbitrator selection or avoidance of cancellation.

Embodiments of the present disclosure include a method wherein after arbitrator selection, the debate will commence and may occur over a specified duration of time, as defined by the claimant during initiation of the claim. One or more alternative time intervals may be modified by a claimant or counter-claimant, such as adding a certain amount of reply time each time a new argument is submitted to allow all parties to have sufficient time to address new arguments, or having the debate continue until a consensus among the presiding arbitrators is reached, wherein the debate shall end upon the occurrence of the anticipated event. The changes to the time intervals may also be applied by a moderator to individual arguments or nodes within an ongoing debate tree to ensure that all arguments can be addressed satisfactorily.

Embodiments of the present disclosure include a method wherein after presentation of the evidence and claims of a dispute has concluded, disputants are given a certain amount of time, possibly in proportion to the duration of the dispute, wherein they may draft and submit a questionnaire comprising one or more questions for the participating arbitrators to answer and submit back to the disputants within a specific time interval. Arbitrators may be required or provided the opportunity to cast one or more votes during this time interval.

Embodiments of the present disclosure include a method including that once both disputants have submitted their questionnaires to the arbitrators, or their allotted time has expired, arbitrators are provided access to the questionnaires, and provided a form wherein they may respond to the contents of said questionnaires for a certain interval of time, possibly in proportion to the duration of the dispute. Arbitrators may be required or provided the opportunity to cast one or more votes during this time interval.

Embodiments of the present disclosure include a method that after all the arbitrators have submitted their responses to the questionnaires, or their allotted time to respond has expired, disputants are given access to the responses of the jurors, which are anonymized when presented back to the disputants. The disputants are subsequently provided a secondary form wherein they may rank the arbitrator responses within a certain amount of time, possibly in proportion to the duration of the debate. Arbitrators may be required or provided the opportunity to cast one or more votes during this time interval.

Embodiments of the present disclosure include a method including that once the disputants have finalized their ranking or failed to submit rankings in the allotted time interval in which case neutral rankings will be applied, and all votes from arbitrators have been cast or the allotted time interval has expired, the dispute will be considered to be fully concluded and the final judgment will be rendered based on the described method of weighting arbitrators' votes.

One potential avenue of abuse by arbitrators acting in bad faith may be to employ other people or AI to draft responses to questionnaires submitted by disputants. An arbitrator acting in good faith, who drafts their own responses to a questionnaire, is more likely to receive a higher score from the disputant they agree with than the disputant they disagree with. This consideration may also be true of arbitrators acting in bad faith, but to a lesser degree. In such cases, said arbitrator would be less likely than an arbitrator who drafted their own responses to receive a higher score from the disputant.

It is contemplated that disputed and resolved claims can be listed publicly on a searchable database. The database by sorted be category or other parameters of the claims. An AI algorithm sort claims displayed by relevance to an individual user's interest. Claims can also be linked to from external media.

Debates and dispute resolutions hosted on this network may possibly hold academic value, and thus, at the consent of the disputants, the disputant may choose to publish their debate for no cost or a decided upon cost to other uses. Specific areas of academic interest may be identified among the users with the aid of artificial intelligence. Identified areas of interest may be used to curate debates and claims listed on the network to its users.

Artificial intelligence tools may be applied to one or more user interactions to identify areas of interest corresponding to commercial products and potential advertisements.

The terms “first,” “second,” and the like, herein do not denote any order, quantity, or importance, but rather are used to distinguish one element from another. Further, the terms “a” and “an” herein do not denote a limitation of quantity, but rather denote the presence of at least one of the referenced items.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of operations may be rearranged. A process may have additional steps not included in the figures. Furthermore, embodiments of the methods may be implemented by hardware, software, firmware, middleware, microcode, hardware descriptions languages, or any combination thereof. When implemented in software, firmware, middleware, or microcode, the program code or code segments to perform the associated tasks may be stored in a computer-readable medium such as a storage medium. Processors may perform the associated tasks.

It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should be interpreted to limit the scope of the claimed embodiments.

Specific details are given in the description to provide a thorough understanding of the embodiments. However, it will be understood by one having ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the embodiments disclosed herein. Rather, the preceding description of the embodiments will provide those skilled in the art with an enabling description for implementing various embodiments disclosed herein. Various changes may be made in the function and arrangements of elements without departing from the spirit and scope of embodiments disclosed herein.

Having described several embodiments, it will be recognized by those of skill in the art that various modifications, alternative constructions, and equivalents may be used without departing from the spirit of the embodiments disclosed herein. For example, the above elements may merely be a component of a larger system, wherein other rules may take precedence over or otherwise modify the application of the embodiments disclosed herein. Also, a number of steps may be undertaken before, during, or after the above elements are considered. Accordingly, the above description should not be taken as limiting the scope of the embodiments disclosed herein.

What is claimed is:

1. A method of mitigating bias in a disputed result comprising:
providing a claimant with the disputed result comprising a claim and a set of claimed facts;
providing a counter-claimant that has a counter-claim and a set of counter-claimed facts;
providing one or more arbitrators, comprising at least a first arbitrator, a second arbitrator, and a third arbitrator;
providing one or more moderators;
moderating a first comparison comprising the claimant and counter-claimant each submitting one or more argument in favor of the claim or the counter-claim to the arbitrators over a specified duration;
moderating a second comparison comprising the claimant's set of claimed facts and the counter-claimant's set of counter-claimed facts to the arbitrators over a specified duration;
producing a composite of arbitrator scores based on combining the first comparison and the second comparison, wherein the composite of arbitrator scores is comprising a first arbitrator score, a second arbitrator score, and third arbitrator score scored separately by both the claimant and the counter-claimant;
producing a claimant ranking of the composite of arbitrator scores;
producing a counter-claimant ranking of the composite of arbitrator scores;
comparing the counter-claimant ranking to the claimant ranking and producing a disputant ranking; and
mitigating the bias of the first arbitrator, a second arbitrator, and a third arbitrator in the disputed result based on the disputant ranking.

2. The method of claim 1 further comprising:
ranking the first arbitrator, the second arbitrator, and the third arbitrator based on the disputant ranking;
assigning a Steelman Score to the first arbitrator, the second arbitrator, and the third arbitrator, respectively, based on the disputant ranking;
calculating a Maximum Steelman Scores; and
updating the Maximum Steelman Score of the first arbitrator, the second arbitrator, and the third arbitrator in a database based on the disputant ranking for selection to arbitrate future disputes.

3. The method of claim 2 further comprising:
providing a dispute budget;
calculating a first arbitrator award compensation based on: a Steelman Score sum comprising the Steelman Score to the first arbitrator, the second arbitrator, and the third arbitrator; and of the Steelman Score of the first arbitrator, the dispute budget, and the number of arbitrators; and
delivering the award compensation to a digital wallet held by the first arbitrator, second arbitrator, and third arbitrator upon resolution of the disputed results.

4. The method of claim 3 further comprising:
calculating a first arbitrator rating based on the first arbitrator award compensation and an arbitrator constant.

5. The method of claim 4, further comprising:
calculating a Minimum Steelman Scores;
calculating a Total Steelman Scores; and
calculating a first moderator award compensation based on the dispute budget, the Maximum Steelman Scores, the Minimum Steelman Scores, and the Total Steelman Scores.

6. The method of claim 5, further comprising:
calculating a first moderator rating based on the first moderator award compensation and a moderator constant.

7. The method of claim 6, further comprising:
selecting the number of arbitrators by combining the first arbitrator rating with the dispute budget further including budget threshold value.

8. The method of claim 7, further comprising:
selecting the moderator by combining the first moderator rating and the dispute budget.

9. The method of claim 8 further comprising providing one or more questionnaires including a claimant test and a counter-claimant test, wherein the claimant test is authored by the claimant and the counter-claimant test is authored by the counter-claimant.

10. The method of claim 9, wherein producing the composite of arbitrator scores further comprises combining the first comparison, the second comparison, and the questionnaire, wherein the composite of arbitrator scores further comprises a first arbitrator questionnaire score, a second arbitrator questionnaire score, and third arbitrator questionnaire score.

11. The method of claim 10, wherein producing the disputant ranking further comprises:
weighting the first arbitrator score by comparing the claimant test and the counter-claimant test to the first arbitrator score,
weighting the second arbitrator score by comparing the claimant test and the counter-claimant test to the second arbitrator score; and
weighting the third arbitrator score by comparing the claimant test and the counter-claimant test to the third arbitrator score.

12. A method comprising:
determining a claim submission via a hardware processor by combining a claim submission template, a claimant including a claimant stake, a counter-claimant including a counter-claimant stake, and an arbitration budget from an online input portal;
transmitting the claim submission to a claim database enabled to communicate with a network,
distributing the claim submission from the claim database to the counter-claimant via the hardware processor and the network;
notifying one or more arbitrators based on their current prestige ranking and requested budget of the claim submission to be arbitrated;
selecting a plurality of arbitrators from an arbitrator database, the arbitrator database comprising a set of arbitrators including a set of arbitrator prestige rankings;
selecting one or more moderators from a moderator database, the moderator database comprising a set of moderators including a set of moderator rankings;
Identifying a claim fact and a counter-claim fact set via the hardware processor by combining the claim submission template, a claimant position, and a counter-claimant position;
producing a set of arbitrator votes regarding the strength of each claimant's position via the hardware processor by combining the claim fact set with the claimant stake and the counter-claimant stake, as well as combining the counter-claim fact set with the claimant stake and the counter-claimant stake;
collecting the set of arbitrator votes via an arbitrator vote template configured to communicate with the network;
transmitting the set of arbitrator votes to the claimant and the counter-claimant via the network;
creating a claimant-ranked set of the arbitrators, and a counter-claimant-ranked set of the arbitrators by each the claimant and counter-claimant by combining the claimant position and the claimant stake via the hardware processor and comparing to the set of arbitrator votes, and by combining the counter-claimant position and the counter-claimant stake via the hardware processor and comparing to the set of arbitrator votes, respectively;
producing a weighted arbitrator vote set via the hardware processor by comparing the claimant-ranked set of arbitrators and the counter-claimant-ranked set of arbitrators to the set of arbitrator votes, the weighted arbitrator vote set including a claimant success set and a counter-claimant success set;
selecting the prevailing party via the hardware processor by comparing the claimant success set and the counter-claimant success set; and
transmitting via a communication interface, the prevailing party.

13. The method of claim 12, wherein selecting the plurality from the arbitrator database further comprises:
assigning a prestige ranking to each of the plurality of arbitrators based on a weighted historical arbitrator vote set wherein the arbitrator database further comprises a historical arbitrator vote set, a historical claimant-ranked set of arbitrators, a counter-claimant set of arbitrators and a historical arbitration budget, and a historical prevailing party;
producing the weighted historical arbitrator vote set by via the hardware processor by comparing the historical arbitrator vote set, the historical claimant-ranked set of arbitrators, the counter-claimant set of arbitrators, the historical arbitration budget, and the historical prevailing party; and
comparing the arbitration budget to the prestige ranking of each of the plurality of arbitrators.

14. The method of claim 13, wherein producing the weighted historical arbitrator vote set further comprises comparing the historical arbitrator vote set, the historical claimant-ranked set of arbitrators, the counter-claimant set of arbitrators, the historical arbitration budget, and the historical winner with an arbitrator Schelling factor, wherein the arbitrator database is further configured to comprise the arbitrator Schelling factor.

15. The method of claim 14, wherein determining the claim submission further comprises:
transmitting a claimant-Turing test and a counter-claimant Turing test via the network to the arbitrator vote template further configured to contain an arbitrator Turing set; and
creating and delivering the arbitrator Turing set via the hardware processor by submitting the claimant-Turing test and the counter-claimant Turing test to the plurality of arbitrators.

16. The method of claim 15, wherein determining the claim submission further comprises producing the weighted arbitrator vote set via the hardware processor by further comparing the claimant-ranked set of arbitrators and the counter-claimant-ranked set of arbitrators to the arbitrator Turing set.

17. The method of claim 16, wherein determining the claim submission further comprises selecting the plurality from the arbitrator database including a set of arbitrator geolocation elements, and further comprises:
diversifying the possible set of arbitrators via the hardware processor by comparing the set of arbitrators to the set of arbitrator geolocation elements.

18. The method of claim 17, wherein determining the claim submission further comprises:
identifying a set of claimant geolocation elements and a set of counter-claimant geolocation elements; and
wherein selecting the plurality from the arbitrator database further comprises comparing the set of arbitrator geolocation elements to the set of claimant geolocation elements and the set of counter-claimant geolocation elements.

19. The method of claim 18, wherein determining the claim submission further comprises:
geo-weighting the weighted arbitrator vote set via the hardware processor by comparing the set of arbitrator geolocation elements to the claim fact and the counter-claim fact set.

20. The method of claim 19, wherein determining the claim submission further comprises:
delivering the staked share of the arbitration budget to the prevailing party, and distributing the arbitration share of the arbitration budget to the set of arbitrators to one or more digital wallets provided by the prevailing party and by the set of arbitrators.
